(19) United States
(12) Patent Application Publication
(10) Pub. No.: US 2010/0301601 A1
(43) Pub. Date: Dec. 2, 2010

(54) FLUID COUPLING FOR A DIRECT INJECTION ENGINE

(75) Inventors: William Harvey, Brighton, MI (US); Steven Miller, Livonia, MI (US); Hiroaki Saeki, West Bloomfield, MI (US)

Correspondence Address: GIFFORD, KRASS, SPRINKLE,ANDERSON & CITKOWSKI, P.C, PO BOX 7021, TROY, MI, 48007-7021, US

(73) Assignee: Hitachi Automotive Products (USA), Inc.

(21) Appl. No.: 12/475,970

(22) Filed: Jun. 1, 2009

(51) Int. Cl. F16L 25/00

(52) U.S. Cl. 285/334.5

(57) ABSTRACT

A fluid coupling for a fuel system in a direct injection internal combustion engine having a body with a ball portion and a fluid passageway extending through the ball portion. The body also includes external threads which extend concentrically around the ball. A tube has an outwardly flared end while both a ferrule and a nut are disposed over the tube. The nut includes internal threads which threadably engage the external threads on the body so that, upon tightening, the nut compresses the outwardly flared portion of the tube in between the ferrule and the ball thus sealingly coupling the tube to the body in fluid communication with the passageway formed through the ball.

### BACKGROUND OF THE INVENTION

I. Field of the Invention

The present invention relates to a fluid coupling for the fuel system of a direct injection engine.

II. Description of Related Art

Direct injection internal combustion engines have enjoyed increased popularity over the previously known multipoint fuel injection engines. This increased popularity of the direct injection engine is due in large part to the higher efficiency, and thus better fuel economy, for the direct injection engine.

In the direct injection engines at least one and preferably several fuel injectors are mounted to a fuel rail. The fuel rail is then attached to the engine block while the fuel injectors each have one end open to their associated combustion chamber. Consequently, pressurized fuel from the fuel rail is injected directly into the internal combustion chamber.

Since the pressures within the combustion chambers are necessarily high at the point of the fuel injection, high pressure fuel must be supplied to the fuel rail. In order to achieve this, a pump, typically a cam-type pump, pumps fuel through a fuel line from the fuel pump and to the fuel rail.

The fuel line connecting the fuel pump to the fuel rail is typically made of metal. A fluid coupling at one end of the fuel line attaches the fuel line to the outlet from the fuel pump while, conversely, a coupling at the other end of the fuel line couples the fuel line to its associated fuel rail.

In order to form these couplings at the ends of the fuel line, typically a small ball having a throughbore was positioned at each end of the line so that the fuel line extended into the throughbore formed through the ball. The ball was then brazed to the fuel line.

The other part of the fuel coupling at the outlet from the fuel pump and inlet to the fuel rail included a conical seat into which the ball was inserted. A nut over the fuel line, upon tightening, compressed the ball against the conical seat thus forming the fluid seal between the ball and its seat.

These previously known fluid couplings, however, have not proven wholly satisfactory in use. In particular, the attachment of the ball to each end of the fuel line is not only time consuming, but also labor intensive. As such, the fuel line with its attached balls at each end appreciably increased the overall cost of the fuel system.

A still further disadvantage of these previously known couplings for the ends of the fuel line is that it has been found difficult to achieve a 100% satisfactory fluid seal between the ball and its seat during the actual production of the engines. This is undesirable since the automotive industry for safety and other reasons requires a 100% seal at the ends of the fuel line for each of the manufactured engines.

### SUMMARY OF THE PRESENT INVENTION

The present invention provides a fluid coupling for attaching the fuel line to the fuel pump outlet and fuel rail inlet which overcomes the above-mentioned disadvantages of the previously known systems.

In brief, the present invention comprises a body at the outlet from the fuel pump or inlet to the fuel rail having a ball portion with a fluid passageway extending through the ball portion. The body also has external threads which extend concentrically around the ball portion.

A tube is outwardly flared at its end while a ferrule is disposed around the tube. A nut is also disposed around the tube so that the ferrule is positioned in between an annular surface on the nut and the outer surface of the flared end of the tube.

The nut includes internal threads which threadably engage the external threads on the body. Consequently, upon tightening of the nut, the annular nut surface compresses against the ferrule which, in turn, compresses the flared end of the tube into sealing engagement with the ball portion thus completing the fluid seal.

In a second embodiment of the invention, the nut includes an outwardly flared portion adjacent its end while the end of the tube is bent retrorsely into the outwardly flared portion. In this embodiment, the ferrule is omitted. Instead, the annular nut surface, upon tightening of the nut, compresses the double thickness flare at the end of the tube into sealing engagement with the ball.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a fuel system for a direct injection engine;

FIG. 2 is an exploded elevational view illustrating a preferred embodiment of the fluid coupling of the present invention;

FIG. 3 is a longitudinal sectional view of the preferred embodiment of the invention;

FIG. 4 is a view similar to FIG. 2, but illustrating a modification thereof; and

FIG. 5 is a view similar to FIG. 3, but illustrating a modification thereof.

### DETAILED DESCRIPTION OF PREFERRED EMBODIMENTS OF THE PRESENT INVENTION

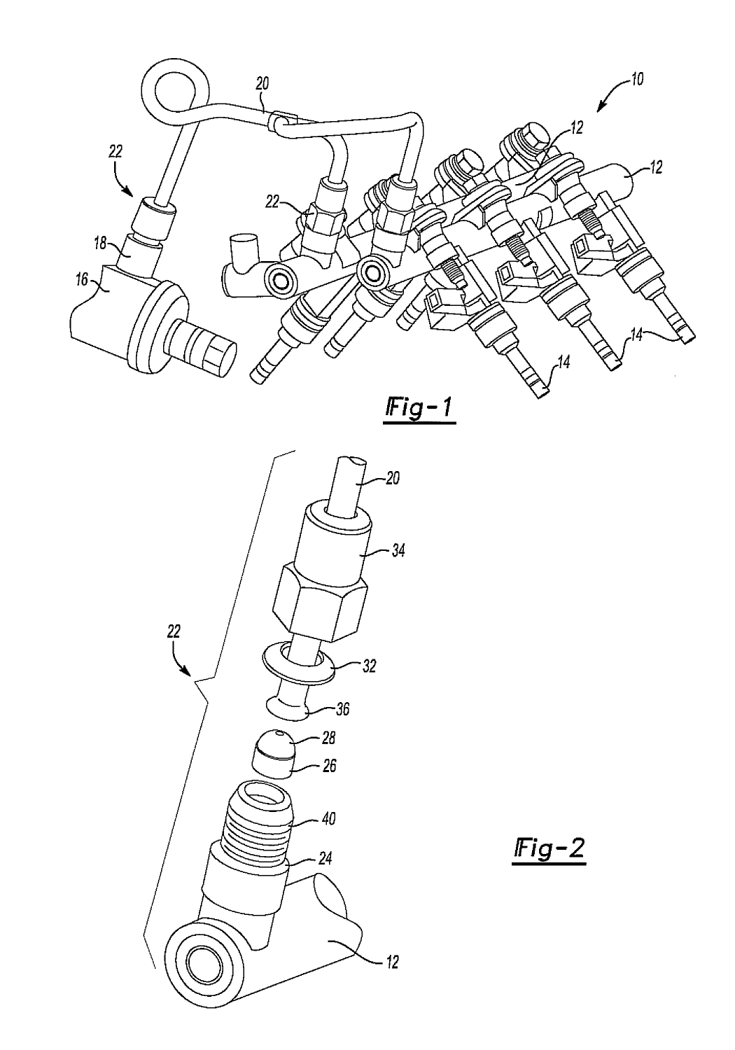

With reference now particularly to FIG. 1, a fuel system 10 for a direct injection internal combustion engine is shown. The fuel system 10 includes a pair of fuel rails 12, each having a plurality of fuel injectors 14 secured to and fluidly connected to the interior of its associated fuel rail 12. The fuel system 10 illustrated in FIG. 1 is shown as a six cylinder engine, but it will be understood that this is by way of example only and that the fuel system 10 may include fewer or more fuel injectors 14.

A fuel pump 16 having an outlet 18 is fluidly connected by a tube 20 to the fuel rails 12. Consequently, upon operation of the pump 16, pressurized fuel is supplied by the pump 16, through the tube 20 and to the interior of each fuel rail 12. From the fuel rail 12, the pressurized fuel is supplied to the engine combustion chambers under control of the engine control unit (not shown) by the fuel injectors 14.

The tube 20 is connected at one end to the fuel pump 16 by a fluid coupling 22. Similarly, the same type of fluid coupling 22 is employed to fluidly connect the opposite end of the tube 20 to the respective fuel rails 12. Since the fluid couplings at both ends of the tube 20 are substantially identical to each other, only one will be described in detail, it being understood that a like description shall also apply to the other fluid coupling or couplings.

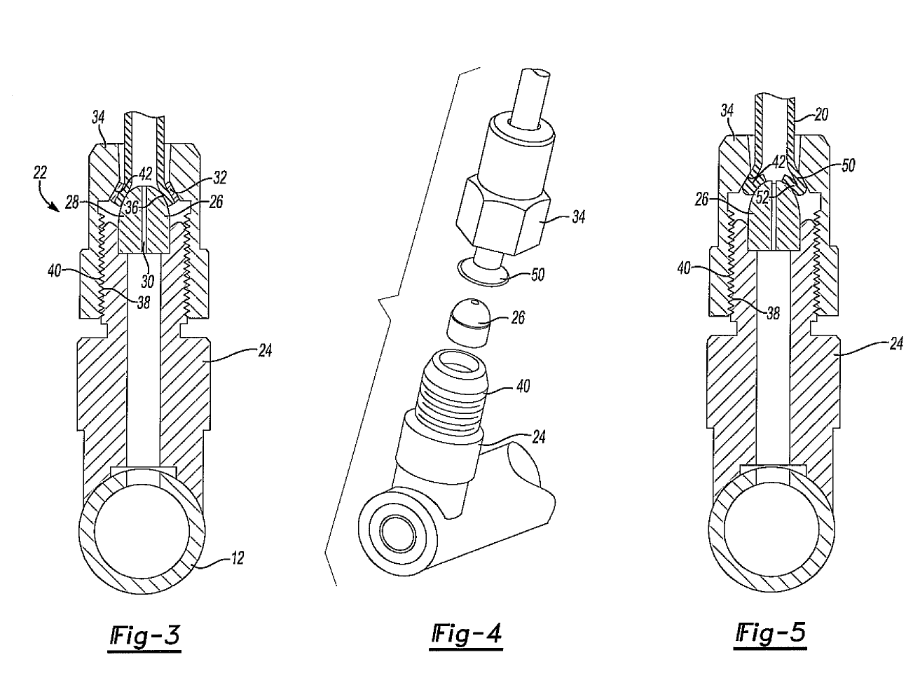

With reference then to FIGS. 2 and 3, the fluid coupling 22 is shown in greater detail and includes a body 24 which is attached to the fuel rail 12 at one end, as shown in FIGS. 2 and 3, or to the pump outlet 18 at the other end. The body 24, furthermore, includes a ball portion 26 which may be either separately formed from the main portion of the body 24, as shown, or integrally constructed with the body 24. The ball portion 26, furthermore, includes a spherical outer surface 28 as well as a fluid passageway 30 which extends through the housing 24 as well as the ball portion 26.

Still referring to FIGS. 2 and 3, an annular ferrule 32 as well as a nut 34 are disposed over the tube 20 and the end of the tube 20 is expanded to form an outwardly flared end 36. The ferrule 32, furthermore, is shaped so that its inner surface substantially flatly abuts against the outer surface of the outwardly flared end 36 of the tube 20 as best shown in FIG. 3.

With reference now particularly to FIG. 3, the nut 34 includes internal threads 38 which are dimensioned to threadably engage external threads 40 formed concentrically around the ball portion 26 on the body 24. Upon tightening of the nut 34, an annular surface 42 on the nut 34 compresses the ferrule against the outer flared end 36 of the tube and, in turn, the outer flared end 36 of the tube 20 against the spherical surface 28 of the ball portion 26. Deformation of the outwardly flared end 36 of the tube 20 upon tightening of the nut 34 creates a fluid-tight coupling between the tube 20 and the housing 24 in the desired fashion.

In order to enhance the sealing action of the tube 20 to the body 24, the tube 20 is preferably constructed of stainless steel, while the ferrule 32, nut 34 and ball portion 26 are all constructed of steel, preferably stainless steel, or steel coated with a rust-resistant coating. The ball portion 26 is also preferably harder than the tube 20, such as hardened steel. Consequently, upon tightening of the nut 34, only the outwardly flared end 36 of the tube 20 deforms in a significant amount.

With reference now to FIGS. 4 and 5, a modification of the present invention is shown in which the annular ferrule 32 (FIGS. 2 and 3) is omitted. Instead, the tube includes an outwardly flared portion 50 adjacent its end while the end 52 of the tube 20 is retrorsely bent inwardly against the outwardly flared tube portion 50. Consequently, the outwardly flared portion 50, together with the end 52 of the tube 20, together form a conical or outwardly flared end of the tube 20 having a thickness of twice the wall thickness of the tube 20.

The outwardly flared end of the tube 20 is positioned against the ball portion 26 as shown in FIG. 5 and the nut 34 is tightened. In doing so, the nut surface 42 compresses the end 52 of the tube 20 against the ball portion 26 to form the fluid seal between the tube 20 and body 24. The double thickness for the outwardly flared end of the tube 20 ensures that there is sufficient material on the tube 20 to form the fluid seal.

From the foregoing, it can be seen that the present invention provides an improved fluid coupling for the fuel system of a direct injection internal combustion engine which may be easily and inexpensively manufactured without any compromise in its effectiveness. In particular, with the fluid coupling of the present invention, it is no longer necessary to braze the balls to the ends of the tube as has been the previous practice.

Having described our invention, however, many modifications thereto will become apparent to those skilled in the art to which it pertains without deviation from the spirit of the invention as defined by the scope of the appended claims.

We claim:

1. A fluid coupling for a fuel system in a direct injection internal combustion engine comprising:
a body having a ball portion and a fluid passageway extending through said ball portion, said body having external threads extending concentrically around said ball portion,
a tube having an outwardly flared end,
a ferrule disposed around said tube, said ferrule having a first surface which abuts against an outer surface of said flared end of said tube,
a nut disposed over said tube so that said ferrule is sandwiched between an annular surface on said nut and said outer surface of said flared end of said tube, said nut having internal threads dimensioned to threadably engage said external threads on said body,
wherein upon tightening of said nut onto said body, said nut annular surface compresses against said ferrule which in turn compresses said flared end of said tube into sealing engagement with said ball portion.

2. The fluid coupling as defined in claim 1 wherein said tube is made of steel.

3. The fluid coupling as defined in claim 2 wherein said metal comprises stainless steel.

4. The fluid coupling as defined in claim 1 wherein said ball portion is made of a harder material than said tube.

5. The fluid coupling as defined in claim 1 wherein said nut is made of steel.

6. A fluid coupling for a fuel system in a direct injection internal combustion engine comprising:
a body having a ball portion and a fluid passageway extending through said ball portion, said body having external threads extending concentrically around said ball portion,
a tube having an outwardly flared portion adjacent its end, said end of said tube being retrorsely bent into said outwardly flared portion,
a nut disposed over said tube and having an annular surface which registers with said outwardly flared portion of said tube, said nut having internal threads dimensioned to threadably engage said external threads on said body,
wherein upon tightening of said nut onto said body, said nut annular surface compresses against said outwardly flared portion which in turn compresses said retrorsely bent end of said tube into sealing engagement with said ball portion.

7. The fluid coupling as defined in claim 6 wherein said tube is made of steel.

8. The fluid coupling as defined in claim 7 wherein said metal comprises stainless steel.

9. The fluid coupling as defined in claim 1 wherein said ball portion is made of a harder material than said tube.

10. The fluid coupling as defined in claim 1 wherein said nut is made of steel.
